(19) United States
(12) Patent Application Publication
(10) Pub. No.: US 2008/0122309 A1
(43) Pub. Date: May 29, 2008

(54) Generator with ferromagnetic bobbin

(75) Inventors: Sergei Kolomeitsev, Rochester, MI (US); Douglas Alan Sward, Midvale, UT (US); Glen Carlson, Sandy, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: RT Patent Company, Wilmington, DE (US)

(21) Appl. No.: 11/607,076

(22) Filed: Nov. 29, 2006

(51) Int. Cl. H02K 3/04

(52) U.S. Cl. 310/194

(57) ABSTRACT

An electromechanical machine includes a stator. A rotor is configured to rotate relative to the stator about a rotational axis. A coil extends about the axis and is wound on a bobbin. The bobbin surrounds the axis and has a circumferentially extending pocket in which the coil is located. The bobbin further has a circumferentially-extending overhang section that extends directly over at least a portion of the coil.

### CROSS-REFERENCE TO RELATED APPLICATION

This application claims the benefit of U.S. Provisional Application No. 60/740,402, filed Nov. 29, 2005, which is incorporated herein by reference in its entirety.

### TECHNICAL FIELD

This application relates to motors and generators.

### BACKGROUND

A generator includes a rotatable rotor and a stationary stator. A coil is wound about a bobbin that is coupled to the stator.

### BRIEF DESCRIPTION OF THE DRAWINGS

FIG. 1 is a sectional view of an alternator, having a field coil wound on a ferromagnetic bobbin.

FIG. 2 is an expanded sectional view of the coil and the bobbin of FIG. 1.

FIG. 3 is a sectional view of another alternator, with a coil and a bobbin that differ in shape from those of FIG. 1.

FIG. 4 is an expanded sectional view of the bobbin of FIG. 3.

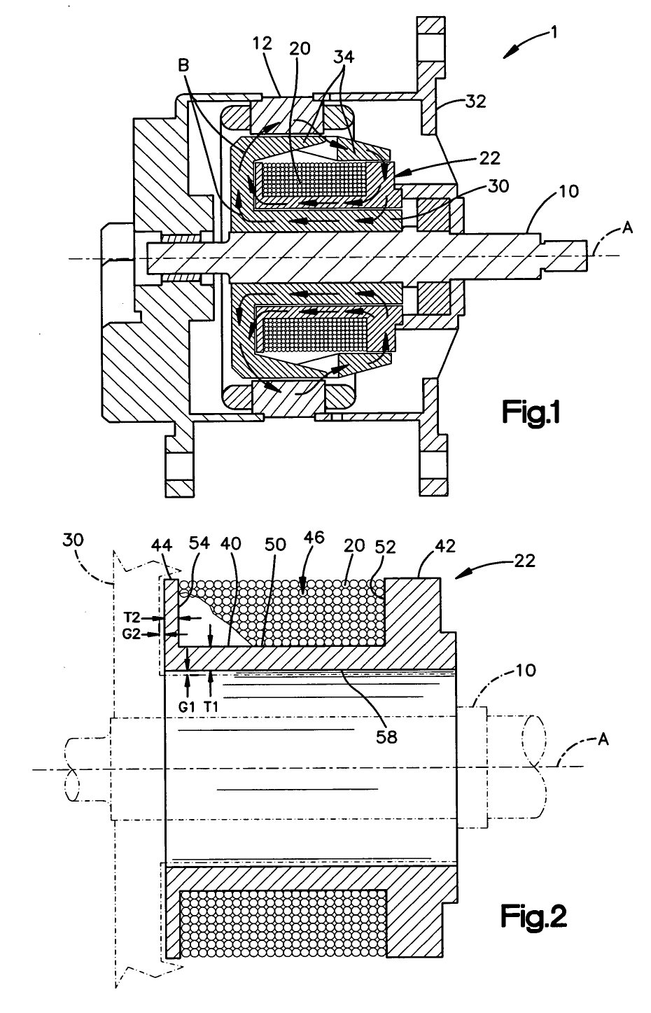

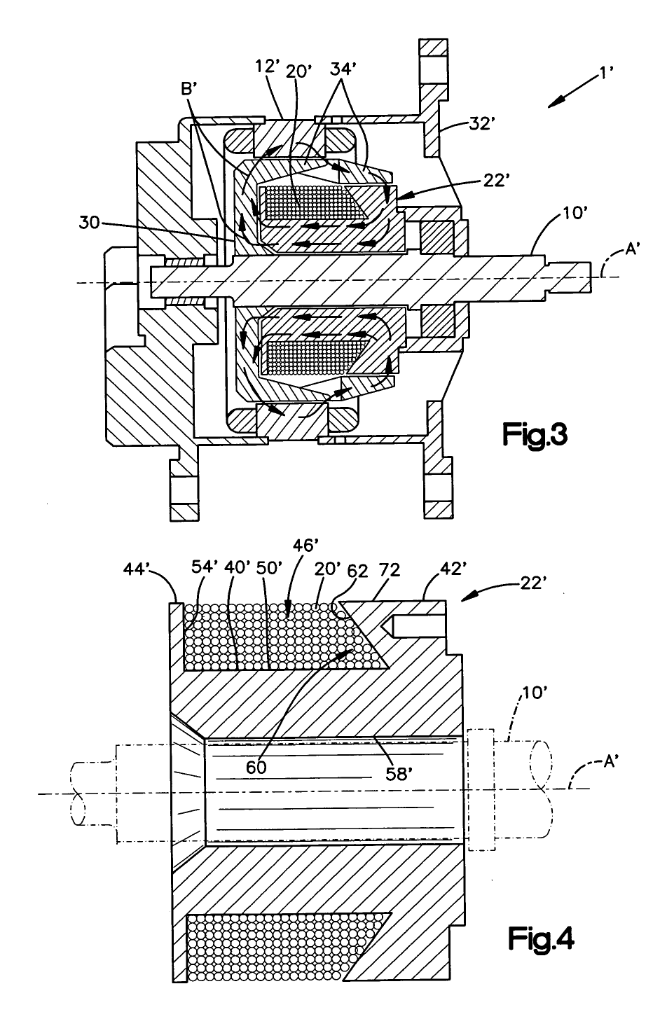

Parts in FIGS. 3-4 labeled with primed numbers correspond to parts in FIGS. 1-2 labeled with corresponding unprimed numbers.

### DESCRIPTION

The apparatus shown in FIGS. 1-4 has parts that are examples of the elements recited in the claims. These examples enable a person of ordinary skill in the art to make and use the invention and include best mode without imposing limitations not recited in the claims.

### FIRST EXAMPLE

FIG. 1 shows an example brushless alternator 1 that generates electricity when its rotor shaft 10 is rotated. The alternator 1 includes a stationary stator 12, a stationary field coil 20 wound about a bobbin 22, and a rotor 30 that includes the shaft 10, all supported by a housing 32. The shaft 10 is centered on a rotational axis A. The rotor 30 has two rotor claws 34 each having a set of fingers, with the fingers of one claw 34 interleaved with the fingers of the other claw 34. The fingers extend between the stator 12 and the coil 20. The rotor 30, including its claws 34, rotates about the axis A relative to the stator 12 and the coil 20. The bobbin 20 is made of ferromagnetic material, such as steel, and can be fully or partially laminated.

As shown in FIG. 2, the bobbin 22 includes three sections. A cylindrically tubular coil-support section 42 supports the coil 20. A mounting section 42 attaches one side of the coil-support section 42 to the housing 32. The mounting section 42, or at least a radially outer portion of it, can be laminated, with radially extending inter-laminate interfaces. A flange section 44 extends radially outward from the opposite side of the coil-support section 42. The coil 20 is bounded by and retained by the three sections 40, 42, 44.

The three sections 40, 42, 44 bound a circumferentially-extending pocket 46 in which the coil 20 is seated. The pocket 46 has a generally rectangular cross-section, defined by a cylindrical bottom surface 50 and two radially outwardly extending side surfaces 52, 54. The bobbin 22 has a cylindrical radially-inner surface 58. The surface 58 is centered on and extends circumferentially about the rotor shaft 10. An insulating material, such as epoxy, lies between the coil 20 and the bobbin 22 to help electrically isolate the coil 20 from the bobbin 22 without affecting the flux B.

The tubular coil-support section 40 has a radially extending thickness T1 and is spaced from the rotor 30 by a radial gap G1. The flange section 44 has an axially extending thickness T2 and is spaced from the rotor 30 by an axial gap G2. Preferably, G1 is uniform along most of or all of the axially extending length of the coil-support section 40 and most of or all of the section's 40 circumference. G2 is uniform along most of or all of the radially extending length of the flange section 44 and most of or all of the section's 44 circumference. Ti is greater than G1 along most of or all of the axially-extending length of the coil-support section 40. T2 is greater than G2 along most of or all of the radially-extending length of the flange section 44. G2 is less than 1.5 times G1 and preferably even less than G1.

As shown in FIG. 1, magnetic flux B surrounding the coil 20 extends through the stator 12, the bobbin 22 and the rotor 30. An axially-extending portion of the flux path (where flux line arrows B point left in FIG. 1) is split between rotor 30 and the bobbin 22. The bobbin 22, being ferromagnetic, conducts the flux B and decreases flux resistance, thus increasing the flux B for a given ampere-turns of the coil 20. This increases efficiency and output wattage, without increasing overall size of the alternator 1.

### SECOND EXAMPLE

FIG. 3 shows another alternator 1′. Its rotor 30′ is smaller than that of FIG. 1. The rotor 30 has a smaller size, and thus lighter weight, which reduces its inertia, which can benefit the alternator drive system such as by reducing belt wear. It also improves manufacturability of the rotor 30 and reduces its parts count. The volume reduction of the rotor 30′ is accompanied by an increase in volume of the ferromagnetic bobbin 22′, by the inner diameter of the bobbin 22′ extending almost to the shaft 10′.

Additionally in contrast to FIG. 1, the bobbin 22′ of FIG. 3 has an undercut 60′, shown more clearly in FIG. 4. The undercut 60′ provides additional space in the pocket 46′ for the coil 20′. This enables the coil's cross-section to be larger than in FIG. 1. The undercut 60 is defined by an annular radially-inwardly facing overhang surface 62. This surface 62 faces the radially-outwardly facing bottom surface 50′. The overhang surface 62 is part of an overhang section 72 of the bobbin 22′ that projects directly over a portion of the pocket 46. The ferromagnetic material of this overhang section 72 adds to the flux path. A portion of the coil 20′ is located in the undercut 60, between the opposing surfaces 50 and 62, and under the overhang section 72.

Although the ferromagnetic bobbin 22, 22′ in this example is used in an alternator, it can alternatively be used in other types of generators, and even other types of electromechanical machines, such as motors.

### SUMMARY

In one aspect of the invention, an electromechanical machine 1 includes a stator 12. A rotor 30 rotates relative to the stator 12 about a rotational axis A. A coil 20 surrounds the axis A and is wound on a bobbin 22. The bobbin 22 surrounds the axis A and has a circumferentially extending pocket 46 in which the coil 20 is located. The bobbin 22 further has a circumferentially-extending overhang section 62 that extends directly over at least a portion of the coil 20. A magnetic field B surrounding the coil 20 can extend through the stator 12, the rotor 30 and the bobbin 22 as the rotor 30 rotates.

The coil 20 can be a field coil. The stator 12, the rotor 30, the bobbin 22 and the coil 20 can be parts of a generator or motor. The bobbin 22 can be formed of steel. The bobbin 22 can include a radially-extending flange section 44 surrounding the axis A and located between the coil 20 and the rotor 30. The flange section 44 can have an axially-extending thickness T2 that is greater than an axial gap G2 between the flange section 44 and the rotor 30. A radial gap G1 between the bobbin 22 and the rotor 30 can be uniform about the axis A. An axial gap G2 between the bobbin 22 and the rotor 30 can be uniform in the radial direction and less than 1.5 times the radial gap G1.

The scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. An electromechanical machine comprising:
a stator;
a rotor configured to rotate relative to the stator about a rotational axis;
a coil surrounding the axis; and
a ferromagnetic bobbin about which the coil is wound, the bobbin surrounding the axis and having a circumferentially extending pocket in which the coil is located and further having a circumferentially-extending overhang section that extends directly over at least a portion of the coil;
for a magnetic field surrounding the coil to extend through the stator, the rotor and the bobbin as the rotor rotates.

2. The machine of claim 1 wherein the coil is a field coil.

3. The machine of claim 1 wherein the stator, the rotor, the bobbin and the coil are parts of a generator.

4. The machine of claim 1 wherein the stator, the rotor, the bobbin and the coil are parts of a motor.

5. The machine of claim 1 wherein the bobbin is formed of steel.

6. The machine of claim 1 wherein the bobbin includes a radially-extending flange section surrounding the axis, the flange section being located between the coil and the rotor and having an axially-extending thickness that is greater than an axial gap between the flange section and the rotor.

7. The machine of claim 1 further comprising a radial gap between the bobbin and the rotor that is uniform about the axis, and an axial gap between the bobbin and the rotor, the axial gap being uniform in the radial direction and less than 1.5 times the radial gap.

8. An electromechanical machine comprising:
a stator;
a rotor configured to rotate relative to the stator about a rotational axis;
a coil surrounding the axis;
a ferromagnetic bobbin having a coil-mount section surrounding the axis and about which the coil is wound, the bobbin further having a flange section extending radially outward from the coil-mount section; and
an axial gap between the flange section and the rotor that is, along most of the radially extending length of the flange section, narrower than the axially extending thickness of the flange section.

9. The machine of claim 8 wherein the coil is a field coil.

10. The machine of claim 8 wherein the bobbin is formed of steel.

11. An electromechanical machine comprising:
a stator;
a rotor configured to rotate relative to the stator about a rotational axis;
a coil surrounding the axis;
a ferromagnetic bobbin, about which the coil is wound, surrounding the axis;
a radial gap, between the bobbin and the rotor, that is uniform in the axial direction; and
an axial gap, between the bobbin and the rotor, that is uniform in the radial direction and less than 1.5 times the radial gap;
configured for a magnetic field surrounding the coil to extend through the stator, the rotor and the bobbin as the rotor rotates.
